(19) United States
(12) Patent Application Publication
(10) Pub. No.: US 2003/0028808 A1
(43) Pub. Date: Feb. 6, 2003

(54) Network system, authentication method and computer program product for authentication

(75) Inventor: Noriyuki Kameda, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/196,526

(22) Filed: Jul. 16, 2002

(30) Foreign Application Priority Data
Aug. 2, 2001 (JP) 2001-235282

(51) Int. Cl. H04L 9/00

(52) U.S. Cl. 713/201

(57) ABSTRACT

Disclosed are a network system which can ensure the security in a LAN environment, an authentication method and a program used therein. A switching hub attains an authentication frame transmitted from a terminal and copies the frame content to use it as an authentication packet for making an inquiry about the authentication of the terminal to an authentication server. The authentication server then retrieves to check whether or not the MAC address included in the authentication packet is stored in an authentication database. In the case where an authentication method is a password, when the password in the authentication packet is correct, the authentication server returns the authentication packet (OK) to the switching hub and, when the MAC address is not stored in the authentication database or the password is incorrect, returns an authentication packet (NG) notifying that the terminal is used by a false user. Therefore, the security in a LAN environment such as Ethernet (registered trademark) and the like can be ensured.

### BACKGROUND OF THE INVENTION

1. Field of the Invention

The invention relates to a network system, the authentication method and the computer program product and, more specifically, to a network system in a LAN (Local Area Network) environment constructed by Ethernet (registered trademark), the authentication method and the computer program product for authentication.

2. Description of the Related Art

In the recent internet environment, mobility tends to be regarded as important. On the other hand, the security performance is still insufficient.

In a PPP (Point to Point Protocol) and a wireless LAN, the security is ensured by performing authentication. However, there has been no method being introduced to ensure the security in Ethernet by performing authentication or the like in a data link layer.

For example, in IPv6 (Internet Protocol Version 6), an IP address can be given by obtaining prefix from a router by simply connecting a terminal to a network. Also, a link local address which can be used on the same link can be automatically generated.

However, there is a risk under such environment that communication on the same link can be attacked (interfered) to some extent or snooped by connecting a terminal if there is a user with malicious intent.

For example, if the terminal has less mobility (in a closed environment) in a LAN environment, the users are limited so that there causes no problem. However, it is crucial in the case where the terminals are frequently moved such as a mobile IP and the like.

### SUMMARY OF THE INVENTION

The invention has been designed to overcome the foregoing problems. An object of the invention is to provide a network system which can ensure the security in a LAN environment and the authentication method and the computer program product for authentication.

In order to achieve above mentioned object, a network system according to present invention comprising: a switching hub having a plurality of connection ports and an authentication server for authenticating a validity of a terminals connected to the switching hub via the connection ports, each of which is connected to one another via a router, wherein: the switching hub authenticates the validity of the terminals based on a frame transmitted from the terminals connected via the connection ports.

Moreover, the network system according to present invention, wherein the switching hub comprises: a reception unit for receiving the frame transmitted from a terminals connected via the connection ports; an authentication packet generator for generating an authentication packet, when the frame received from the reception unit is an authentication frame, based on the authentication packet; and an authentication inquiry unit for making an inquiry about the validity of the terminal to the authentication server using the authentication packet generated by the authentication packet generator.

Moreover, the network system according to present invention, wherein the authentication server comprises: a storage unit for storing authentication information of a terminal to be authenticated beforehand; a retrieving unit for retrieving to check whether or not the authentication information of the authentication packet obtained by the authentication inquiry unit is stored in the storage unit; and an authentication response unit for transmitting authenticated/unauthenticated as an authentication response packet to the switching hub based on the retrieved result by the retrieving unit.

Moreover, the network system according to present invention, wherein the switching hub comprises: a first database for storing a MAC address of a terminal which is authenticated by the authentication response unit and a connection port number connected to the terminal; a second database for storing a MAC address of a terminal which is unauthenticated by the authentication response unit and a connection port number connected to the terminal; and a third database for storing a MAC address of a terminal which is in a process of making an inquiry to the authentication server by the authentication inquiry unit and a connection port number connected to the terminal.

Moreover, the network system according to present invention, wherein the switching hub judges: whether or not a MAC address designated by the frame which is received in the reception unit is stored in the first database; whether or not the MAC address is stored in the second database when it is not stored in the first database; whether or not the frame is an authentication frame when it is not stored in the second database; and whether or not the MAC address is stored in the third database when the frame is the authentication frame data, and wherein: the authentication packet generator generates an authentication packet based on the authentication frame when the MAC address is not stored in the third database.

Moreover, the network system according to present invention, wherein the switching hub comprises an aborting unit for aborting the frame when the MAC address designated by the frame which is received in the reception unit is stored either in the second database or the third database.

Moreover, the network system according to present invention, wherein the switching hub comprises a transfer unit for transferring the frame when the frame received in, the reception unit is a transfer target.

Moreover, an authentication method of a network system comprising a switching hub having a plurality of connection ports, and an authentication server for authenticating a validity of a terminals connected to the switching hub via the connection ports, each of which is connected to one another via a router, wherein: the switching hub performs the steps of: receiving a frame transmitted from a terminals connected via the connection ports; generating an authentication packet, when the frame received from the reception unit is an authentication frame, based on the authentication frame; and making an inquiry about the validity of terminal to the authentication server using the authentication packet generated by the authentication packet generating step, and wherein the authentication server performs the steps of: storing authentication information of terminals to be authenticated beforehand; retrieving to check whether or not the authentication information of the authentication packet obtained by the authentication inquiry unit is stored by the storing step; and transmitting authenticated/unauthenticated as an authentication response packet to the switching hub based on the retrieved result by the retrieving step.

Moreover, the authentication method of a network system according to present invention, wherein the switching hub comprises: a first storing step for storing a MAC address of a terminal which is authenticated by the authentication response step and a connection port number connected to the terminal; a second storing step for storing a MAC address of a terminal which is unauthenticated by the authentication response step and a connection port number connected to the terminal; and a third storing step for storing a MAC address of a terminal which is in a process of making an inquiry to the authentication server by the authentication inquiry step and a connection port number connected to the terminal.

Moreover, the authentication method of a network system according to present invention, wherein the switching hub comprises: a first judging step for judging whether or not a MAC address designated by the frame received in the reception unit is stored in the first database; a second judging step for judging whether or not the MAC address is stored in the second database when it is judged by the first judging step not to be stored in the first database; a third judging step for judging whether or not the frame is an authentication frame when it is judged by the second judging step not to be stored in the second database; and a fourth judging step for judging whether or not the MAC address is stored in the third database when the frame is judged to be the authentication frame data by the third judging step, and wherein: the authentication packet generator generates an authentication packet based on the authentication frame when it is judged by the fourth judging step not to be in the third database.

Moreover, the authentication method of a network system according to present invention, wherein the switching hub performs an aborting step for aborting the frame when the MAC address designated by the frame which is received by the reception step is stored either by the second storing step or the third storing step.

Moreover, the authentication method of a network system according to present invention, wherein the switching hub performs a transfer step of transferring the frame when the frame received by the reception step is a transfer target.

Moreover, a computer program product stored in storage medium for a network system comprising a switching hub having a plurality of connection ports; and an authentication server for authenticating a validity of a terminals connected to the switching hub via the connection ports, each of which is connected to one another via a router, wherein, by the computer program product: the switching hub executes: a reception processing for receiving a frame transmitted from a terminal connected via the connection ports; an authentication packet generating processing for generating an authentication packet, when the frame received by the reception processing is an authentication frame, based on the authentication frame; and an inquiry processing for making an inquiry about the validity of the terminal to the authentication server using the authentication packet generated by the generating step, and wherein, by the computer program product: the authentication server executes: a storing processing for storing authentication information of a terminal to be authenticated beforehand; a retrieving processing for retrieving to check whether or not the authentication information of the authentication packet obtained by the authentication inquiry unit is stored by the storing step; and an authentication response processing for transmitting authenticated/unauthenticated as an authentication response packet to the switching hub based on a retrieved result by the retrieving processing.

Moreover, the computer program product stored in storage medium for a network system according to present invention, wherein the switching hub, by the program, executes: a first storing processing for storing a MAC address of a terminal which is authenticated by the authentication response processing and a connection port number connected to the terminal; a second storing processing for storing a MAC address of a terminal which is unauthenticated by the authentication response processing and a connection port number connected to the terminal; and a third storing processing for storing a MAC address of a terminal which is in a process of making an inquiry to the authentication server by the authentication inquiry processing and a connection port number connected to the terminal.

Moreover, the computer program product for a network system according to present invention, wherein the switching hub, by the program, executes: a first judging processing for judging whether or not a MAC address designated by the frame received by the reception processing is stored by the first storing processing; a second judging processing for judging whether or not the MAC address is stored in the second database when it is judged in the first judging processing not to be stored by the first storing processing; and a third judging processing for judging whether or not the frame is an authentication frame when it is judged in the second judging processing not to be stored by the second storing processing; and a fourth judging processing for judging whether or not the MAC address is stored by the third storing processing when the frame is judged in the third judging processing to be the authentication frame data, and wherein, by the program: the authentication packet generator generates an authentication packet based on the authentication frame when it is judged in the fourth judging processing not to be stored by the third storing processing.

Moreover, the computer program product for a network system according to present invention, wherein the switching hub, by the program, executes an aborting processing for aborting the frame when the MAC address designated by the frame received by the reception processing is stored either by the second storing processing or the third storing processing.

Moreover, the computer program product for a network system according to present invention, wherein the switching hub, by the program, executes a transfer processing for transferring the frame when the frame received by the reception processing is a transfer target.

According to above configuration, the network system of the present invention is a LAN such as Ethernet comprising a plurality of connection ports and, which is constructed by a switching hub capable of housing a plurality of terminals. According to the invention, the security in the network system can be improved while keeping the mobility of the terminals in a network system structure such as IPv6 (Internet Protocol Version 6) with terminals in which communication can be performed by automatically generating the IP address through simply connecting the terminals to the network.

### BRIEF DESCRIPTION OF THE DRAWINGS

FIG. 1 is a block diagram showing a schematic configuration of a network system according to the embodiment of the invention;

FIG. 2 is a flowchart showing an operation example of a switching hub according to the embodiment of the invention;

FIG. 3 is a flowchart showing a reception processing example of an authentication packet from the switching hub in an authentication server; and

FIG. 4 is a flowchart showing a reception processing of an authentication response packet from the authentication server in the switching hub and an example of a stored MAC address processing.

### DETAILED DESCRIPTION OF THE PREFERRED EMBODIMENTS

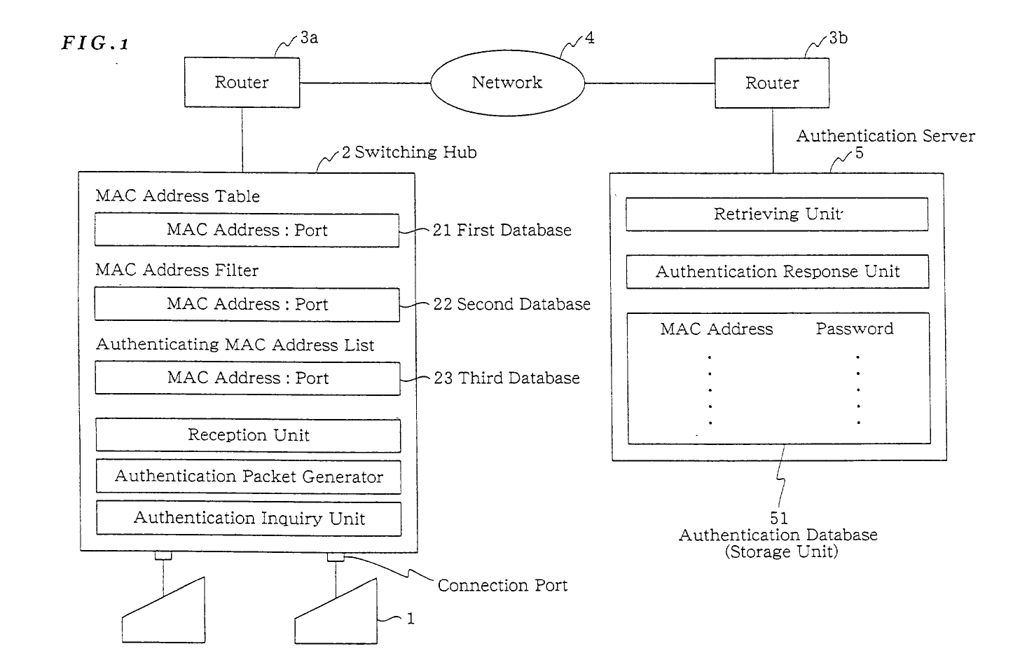

Next, a network system and the authentication method according to the embodiment of the present invention will be described in detail by referring to the accompanying drawings. The embodiment of the network system and the authentication method according to the invention will be shown in FIG. 1 to FIG. 4.

FIG. 1 is a block diagram showing the schematic structure of the network system according to the embodiment of the invention. In FIG. 1, the network system according to the embodiment of the invention includes a plurality of terminals 1, a switching hub 2, routers 3a/3b, a network 4, and an authentication server 5. The terminals 1 are connected to the network 4 via the switching hub 2 and the router 3a. The authentication server 5 is connected to the network 4 via the router 3b.

In the configuration shown in FIG. 1, authentication of the terminal 1 between the switching hub 2 and the terminal 1 is performed using an authentication frame while authentication of the terminal 1 between the switching hub 2 and the authentication server 5 is performed using the authentication packet transmitted from the switching hub 2.

The terminal 1 transmits the authentication frame to the switching hub 2 when an interface becomes usable. For example, the MAC address of the terminal 1, the password as authentication data and the like are included in the authentication frame.

The switching hub 2 comprises a function of attaining the authentication frame transmitted from the terminal 1, and making an inquiry to the authentication server 5 whether or not the terminal 1 is authenticated using the authentication packet generated by copying the content of the authentication frame. Incidentally, the IP address of the switching hub 2 itself and that of the authentication server 5 are registered beforehand in the switching hub 2 for performing communication between the authentication server 5.

The authentication server 5 retrieves an authentication database (storage unit) 51 to check the presence of the MAC address included in the authentication packet inquired by the switching hub 2 via the network 4 in order to verify the authentication method and the authentication data.

The authentication server 5, for example, when a password is used as the authentication method, returns an authentication response packet (OK) to the switching hub 2 if the password inquired by the authentication packet is correct (authentication OK). If the MAC address is not registered to the authentication database 51 or the password is false (authentication NG), the authentication server 5 returns an authentication response packet (NG) for notifying that the terminal is used by a false user.

The switching hub 2, when the terminal 1 is authenticated in the response to the authentication packet from the authentication packet 5, stores the MAC address of the terminal 1 and the connection port (port number) of the terminal 1 in a MAC address table (first database) 21 and transmits the frame from the terminal 1 to the router 3a. The switching hub 2, when the terminal 1 is not authenticated, registers the MAC address of the terminal 1 to a MAC address filter (second database) 22. The MAC address which is unauthenticated for a certain period of time is to be aborted thereafter.

The communication can be performed only with the terminals authenticated by a series of operation described above so that the security can be ensured in a LAN environment.

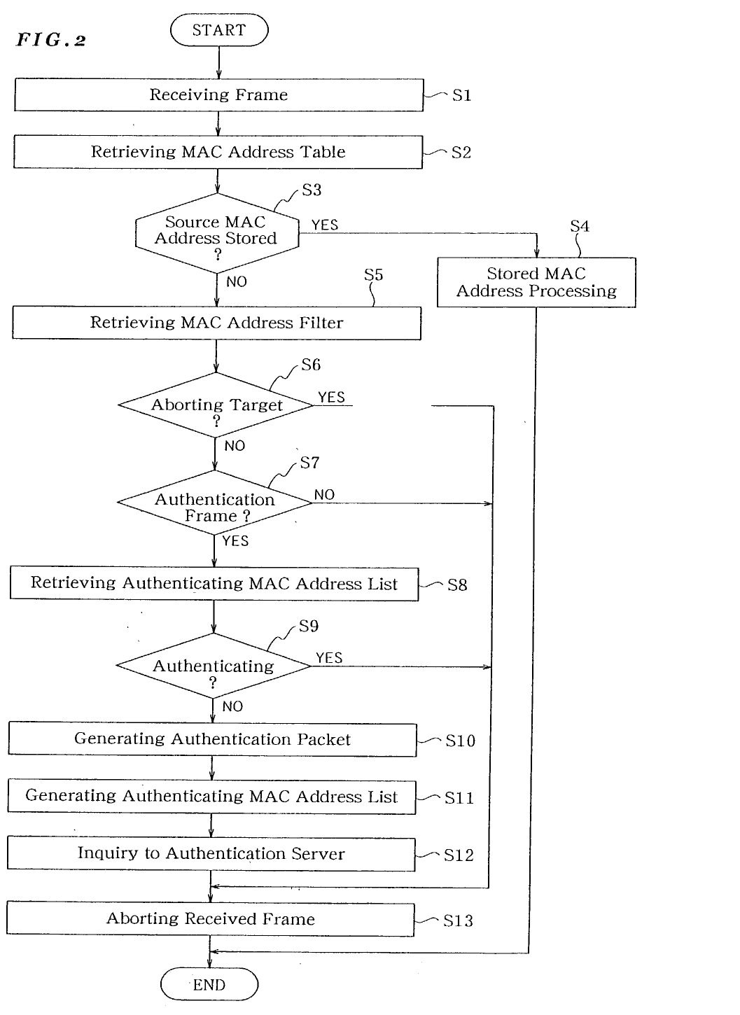

FIG. 2 is a flowchart showing an operation example of the network system according to the embodiment of the invention. The terminal 1 transmits the authentication frame to the switching hub 2 when the interface becomes usable. The MAC address of the terminal 1, the password as authentication data and the like are included in the authentication frame.

The switching hub 2, upon receiving the authentication frame transmitted from the terminal 1 (step S1), executes a retrieving processing for checking whether or not the MAC address designated by the authentication frame is in the MAC address table 21 (step S2).

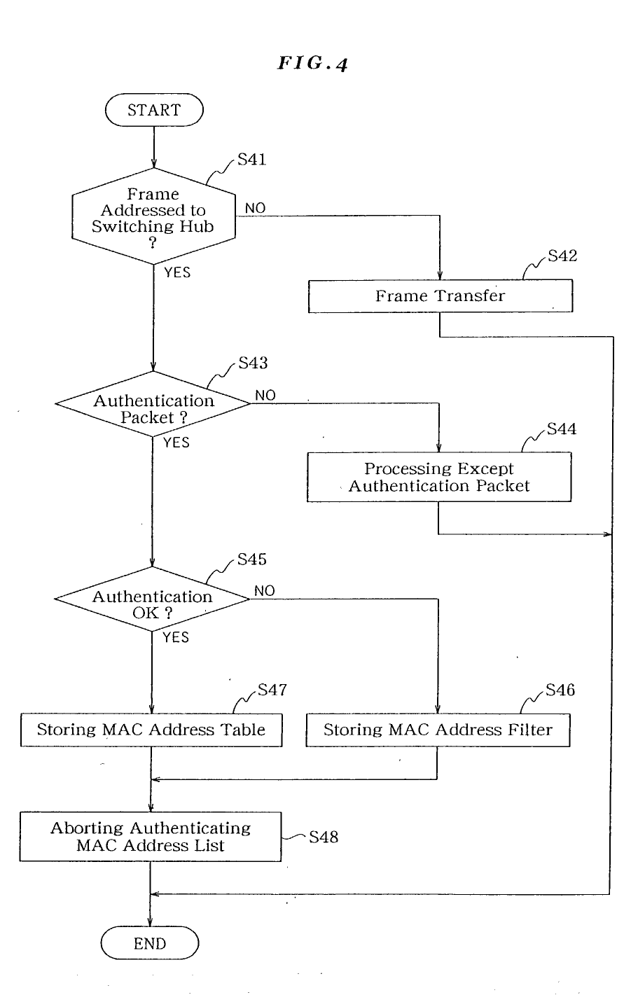

Based on the result of the retrieving processing by the step S2, the switching hub 2, when the MAC address designated by the authentication frame is judged to be in the MAC address table 21 (step S3/YES), performs the stored MAC address processing (step S4) since the MAC address designated by the terminal is guaranteed to be a valid user by the authentication server 5. In the stored MAC address processing, the switching hub 2 judges whether the received frame is for the switching hub 2 itself or the frame to be transferred. If it is a target frame to be transferred, the switching hub 2 performs a transfer processing (see FIG. 4).

In the step S3, when the MAC address designated by the authentication frame is judged not to be stored (step S3/NO) based on the retrieved result of the MAC address table 21, the switching hub 2 executes a retrieving processing to check whether or not the MAC address designated by the authentication frame is in the MAC address filter 22 (step S5).

Based on the retrieved result by the step 5, the switching hub 2, when the MAC address designated by the authentication frame is judged to be in the MAC address filter 22 (step S3/YES), judges the MAC address designated by the terminal 1 to be a false user (to be aborted) that is unauthenticated by the authentication server 5 (step S6/YES) and performs an aborting processing of the received frame (step S13).

Next, the switching hub 2 judges whether or not the received frame of the MAC address frame which is not yet stored in the MAC address filter 22 is an authentication frame (step S7). In the invention, the switching hub 2 is to perform an authentication processing upon receiving the authentication frame transmitted from the terminal. Therefore, when the received frame is judged not to be the authentication frame in the step S7, the switching hub 2 performs an aborting processing of the received frame (step S13).

When the received frame is judged to be the authentication frame (step S7/YES) in the step S7, the switching hub 2 executes a retrieving processing to check whether or not the MAC address designated by the above-described authentication frame is on an authenticating MAC address list (third database) 23 (step S8).

In the retrieving processing by the step S8, the switching hub 2, when the MAC address designated by the authentication frame is judged to be on the authenticating MAC address list 23, that is, the MAC address is in the process of authentication (step S9/YES), performs an aborting processing of the received frame (step S13) since the target MAC address is in the process of making an inquiry about the authentication to the authentication server 5.

In the retrieving processing by the step S8, the switching hub 2, when the MAC address designated by the authentication frame is judged not to be on the authenticating MAC address list, that is, the MAC address is not in the process of authentication (step S9/NO), performs a generating processing of the authentication packet by copying the content of the authentication frame (step S10) in order to make an inquiry about the authentication to the authentication server 5.

The switching hub 2, after generating the authentication packet, generates the authenticating MAC address list 23 (step S11) so as to supervise the authenticating state by storing, on the authenticating MAC address list 23, the MAC address which is the target of inquiry and the connection port number which has received the authentication frame.

The switching hub 2, after generating the authenticating MAC address list 23, makes an inquiry about the authentication to the authentication server 5 (step S12) using the authentication packet generated in the step S10. After completing the inquiry processing, the switching hub 2 performs the aborting processing of the received authentication frame (step S13).

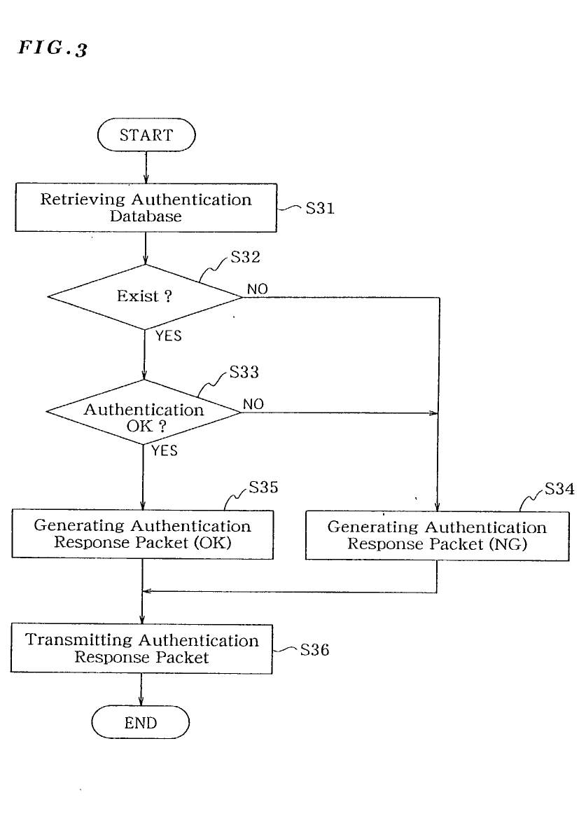

FIG. 3 is a flowchart showing a reception processing example of an authentication inquiry packet in the authentication server. In FIG. 3, the authentication server 5, upon receiving the authentication packet transmitted from the switching hub 2, executes a retrieving processing to check whether or not the MAC address designated by the received authentication packet is in the authentication database 51 (step S31). The authentication server 5, when the MAC address designated by the received authentication packet is judged not to be in the authentication database 51 (step S32/NO), generates an authentication response packet (NG) (step S34) for notifying that it is an authentication error and transmits it to the switching hub 2 as the authentication response packet (step S36).

In the step S32, the authentication server 5, when the MAC address designated by the received authentication is judged to be in the authentication database 51 (step S32/YES), judges whether or not it is authentication OK (step S33) based on the consistency of the authentication data (for example, a password) designated by the authentication packet.

The authentication server 5 judges it to be authentication NG when the authentication data is inconsistent (step S33/NO), and generates an authentication response packet (NG) (step S34) for notifying that it is an authentication error and transmits it to the switching hub 2 as the authentication response packet (step S36).

The authentication server 5 judges it to be authentication OK when the authentication data is consistent (step S33/NO), and generates an authentication response packet (OK) (step S35) for notifying that it is authenticated and transmits it to the switching hub 2 as the authentication response packet (step S36).

FIG. 4 is a flowchart showing a reception processing example of the authentication response packet in the switching hub and an example of a stored MAC address processing. The switching hub 2 rules out the uplink for the router 3a from the authentication target or enables a pre-registration of the MAC address of the router 3a in the MAC address table 21.

In the step S3 in FIG. 2, the switching hub 2, based on the result of the retrieving processing to check whether or not the MAC address designated by the authentication frame is in the MAC address table 21, when the MAC address is judged to be stored (step S3/YES in FIG. 2), judges whether the received frame is for the switching hub 2 or the target frame to be transferred (step S41) as the stored MAC address processing. When the received frame is not for the switching hub 2 itself (step S41/NO), the switching hub 2 performs a transfer processing of the frame (step S42).

In the step 41, the switching hub 2, when the received frame is judged to be for the switching hub 2, judges whether or not the received frame is included in the authentication packet (step S43.)

The switching hub 2, when judging in the step S43 that the authentication packet is not included in the received frame (step S43/NO), executes the processing (step S44) except the authentication packet and stops the processing.

The switching hub 2, when judging in the step S43 that the authentication packet is included in the received frame (step S43/YES), judges whether or not the authentication is correctly performed (step S45) based on the content of the authentication response packet.

The switching hub 2, when the authentication is correctly performed in the step S45 (step S45/YES), stores (stores in the MAC address table 21) the MAC address of the terminal authenticated in the MAC address table 21 and the connection port number connected to the terminal (step S47), and aborts the target MAC address from the authenticating MAC address list 23 (step S48).

The switching hub 2, when the authentication is not performed correctly in the step S45 (step S45/NO), stores (stores in the MAC address filter 22) the MAC address of the terminal which is not authenticated in the MAC address filter 22 and the connection port number connected to the terminal (step S46), and aborts the above-described MAC address from the authenticating MAC address list 23 (step S48).

Each of the structural elements such as the switching hub and the authentication server according to the embodiment of the invention is execute the processing based on the program stored in a ROM (not shown) or the like in order to perform the above -described processing.

As is evident from the description presented above, according to the invention, attacks (interference) to the network by false users can be prevented since the frame from the unauthenticated terminal is aborted in the switching hub (at the entrance of the network). Therefore, an excessive burden imposed on the network can be reduced.

Furthermore, in the invention, authentication is performed in the MAC level (MAC address) so that the routers can be also protected from being attacked. As a result, the security in a LAN environment can be ensured while keeping the mobility of the terminals.

The invention may be embodied in other specific forms without departing from the spirit or essential characteristic thereof. The present embodiments are therefore to be considered in all respects as illustrative and not restrictive, the scope of the invention being indicated by the appended Claims rather than by the foregoing description and all changes which come within the meaning and range of equivalency of the Claims are therefore intended to be embraced therein.

The entire disclosure of Japanese Patent Application No. 2001-235282 (Filed on Aug. 2, 2001) including specification, claims, drawings and summary are incorporated herein by reference in its entirety.

What is claimed is:

1. A network system comprising: a switching hub having a plurality of connection ports and an authentication server for authenticating a validity of a terminals connected to the switching hub via the connection ports, each of which is connected to one another via a router, wherein:
the switching hub authenticates the validity of the terminals based on a frame transmitted from the terminals connected via the connection ports.

2. The network system as claimed in claim 1, wherein the switching hub comprises:
a reception unit for receiving the frame transmitted from a terminals connected via the connection ports;
an authentication packet generator for generating an authentication packet, when the frame received from the reception unit is an authentication frame, based on the authentication packet; and
an authentication inquiry unit for making an inquiry about the validity of the terminal to the authentication server using the authentication packet generated by the authentication packet generator.

3. The network system as claimed in claim 2, wherein the authentication server comprises:
a storage unit for storing authentication information of a terminal to be authenticated beforehand;
a retrieving unit for retrieving to check whether or not the authentication information of the authentication packet obtained by the authentication inquiry unit is stored in the storage unit; and
an authentication response unit for transmitting authenticated/unauthenticated as an authentication response packet to the switching hub based on the retrieved result by the retrieving unit.

4. The network system as claimed in claim 3, wherein the switching hub comprises:
a first database for storing a MAC address of a terminal which is authenticated by the authentication response unit and a connection port number connected to the terminal;
a second database for storing a MAC address of a terminal which is unauthenticated by the authentication response unit and a connection port number connected to the terminal; and
a third database for storing a MAC address of a terminal which is in a process of making an inquiry to the authentication server by the authentication inquiry unit and a connection port number connected to the terminal.

5. The network system as claimed in claim 4, wherein:
the switching hub judges:
whether or not a MAC address designated by the frame which is received in the reception unit is stored in the first database;
whether or not the MAC address is stored in the second database when it is not stored in the first database;
whether or not the frame is an authentication frame when it is not stored in the second database; and
whether or not the MAC address is stored in the third database when the frame is the authentication frame data, and wherein:
the authentication packet generator generates an authentication packet based on the authentication frame when the MAC address is not stored in the third database.

6. The network system as claimed in claim 5, wherein the switching hub comprises an aborting unit for aborting the frame when the MAC address designated by the frame which is received in the reception unit is stored either in the second database or the third database.

7. The network system as claimed in claim 5 or 6, wherein the switching hub comprises a transfer unit for transferring the frame when the frame received in the reception unit is a transfer target.

8. An authentication method of a network system comprising a switching hub having a plurality of connection ports, and an authentication server for authenticating a validity of a terminals connected to the switching hub via the connection ports, each of which is connected to one another via a router, wherein:
the switching hub performs the steps of:
receiving a frame transmitted from a terminals connected via the connection ports;
generating an authentication packet, when the frame received from the reception unit is an authentication frame, based on the authentication frame; and
making an inquiry about the validity of terminal to the authentication server using the authentication packet generated by the authentication packet generating step, and wherein
the authentication server performs the steps of:
storing authentication information of terminals to be authenticated beforehand;
retrieving to check whether or not the authentication information of the authentication packet obtained by the authentication inquiry unit is stored by the storing step; and
transmitting authenticated/unauthenticated as an authentication response packet to the switching hub based on the retrieved result by the retrieving step.

9. The authentication method of a network system as claimed in claim 8, wherein the switching hub comprises:
a first storing step for storing a MAC address of a terminal which is authenticated by the authentication response step and a connection port number connected to the terminal;
a second storing step for storing a MAC address of a terminal which is unauthenticated by the authentication response step and a connection port number connected to the terminal; and
a third storing step for storing a MAC address of a terminal which is in a process of making an inquiry to the authentication server by the authentication inquiry step and a connection port number connected to the terminal.

10. The authentication method of a network system as claimed in claim 9, wherein the switching hub comprises:
a first judging step for judging whether or not a MAC address designated by the frame received in the reception unit is stored in the first database;
a second judging step for judging whether or not the MAC address is stored in the second database when it is judged by the first judging step not to be stored in the first database;
a third judging step for judging whether or not the frame is an authentication frame when it is judged by the second judging step not to be stored in the second database; and
a fourth judging step for judging whether or not the MAC address is stored in the third database when the frame is judged to be the authentication frame data by the third judging step, and wherein:
the authentication packet generator generates an authentication packet based on the authentication frame when it is judged by the fourth judging step not to be in the third database.

11. The authentication method of a network system as claimed in claim 10, wherein the switching hub performs an aborting step for aborting the frame when the MAC address designated by the frame which is received by the reception step is stored either by the second storing step or the third storing step.

12. The authentication method of a network system as claimed in claim 10 or 11, wherein the switching hub performs a transfer step of transferring the frame when the frame received by the reception step is a transfer target.

13. A computer program product stored in storage medium for a network system comprising a switching hub having a plurality of connection ports; and an authentication server for authenticating a validity of a terminals connected to the switching hub via the connection ports, each of which is connected to one another via a router, wherein, by the computer program product:
the switching hub executes:
a reception processing for receiving a frame transmitted from a terminal connected via the connection ports;
an authentication packet generating processing for generating an authentication packet, when the frame received by the reception processing is an authentication frame, based on the authentication frame; and
an inquiry processing for making an inquiry about the validity of the terminal to the authentication server using the authentication packet generated by the generating step, and wherein, by the computer program product:
the authentication server executes:
a storing processing for storing authentication information of a terminal to be authenticated beforehand;
a retrieving processing for retrieving to check whether or not the authentication information of the authentication packet obtained by the authentication inquiry unit is stored by the storing step; and
an authentication response processing for transmitting authenticated/unauthenticated as an authentication response packet to the switching hub based on a retrieved result by the retrieving processing.

14. A computer program product stored in storage medium for a network system as claimed in claim 13, wherein the switching hub, by the program, executes:
a first storing processing for storing a MAC address of a terminal which is authenticated by the authentication response processing and a connection port number connected to the terminal;
a second storing processing for storing a MAC address of a terminal which is unauthenticated by the authentication response processing and a connection port number connected to the terminal; and
a third storing processing for storing a MAC address of a terminal which is in a process of making an inquiry to the authentication server by the authentication inquiry processing and a connection port number connected to the terminal.

15. The computer program product for a network system as claimed in claim 14, wherein the switching hub, by the program, executes:
a first judging processing for judging whether or not a MAC address designated by the frame received by the reception processing is stored by the first storing processing;
a second judging processing for judging whether or not the MAC address is stored in the second database when it is judged in the first judging processing not to be stored by the first storing processing; and
a third judging processing for judging whether or not the frame is an authentication frame when it is judged in the second judging processing not to be stored by the second storing processing; and
a fourth judging processing for judging whether or not the MAC address is stored by the third storing processing when the frame is judged in the third judging processing to be the authentication frame data, and wherein, by the program:
the authentication packet generator generates an authentication packet based on the authentication frame when it is judged in the fourth judging processing not to be stored by the third storing processing.

16. The computer program product for a network system as claimed in claim 15, wherein the switching hub, by the program, executes an aborting processing for aborting the frame when the MAC address designated by the frame received by the reception processing is stored either by the second storing processing or the third storing processing.

17. The computer program product for a network system as claimed in claim 15, wherein the switching hub, by the program, executes a transfer processing for transferring the frame when the frame received by the reception processing is a transfer target.
